(19) United States
(12) Patent Application Publication
(10) Pub. No.: US 2007/0126924 A1
(43) Pub. Date: Jun. 7, 2007

(54) PORTABLE DEVICE WITH INTEGRATED CAMERA

(75) Inventors: ZHENG SHI, Shenzhen (CN); JUN ZHANG, Shenzhen (CN); CHIEN-LI TSAI, Tu-Cheng (TW); CHUN-CHI LIANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,635

(22) Filed: Dec. 1, 2006

(30) Foreign Application Priority Data
Dec. 6, 2005 (CN) 200520120223.8

(51) Int. Cl. H04N 5/225

(52) U.S. Cl. 348/375

(57) ABSTRACT

A portable device with a detachable camera includes a case, a camera detachably received in the case, a wire interconnecting the case and the camera, and a self-winding reel assembly. The self-winding reel assembly includes a reel pivotably received in the case, which has a first end, an opposite second end for winding the wire therebetween and a first blocking portion attached to the second end, a scroll spring attached to the first end providing a rebounding force to the reel, a resilient lock detachably engaging with the first blocking portion, and a reel button engaging with the resilient lock. When the reel button is pressed, the resilient lock is driven to disengage from the first blocking portion, and the scroll spring urges the reel to rewind the wire.

### BACKGROUND OF THE INVENTION

1. Field of the Invention

The present invention relates to portable devices, and particularly to a portable device with an integrated camera.

2. Description of Related Art

Nowadays, cameras are widely used in portable devices such as notebook computers. The portable device generally includes an upper case having a display accommodated therein, a lower case having a plurality of electronic modules such as CPU (center processing unit), video card, sound card and etc. therein. The camera is generally integrated in the upper case to collect various images and transmit these images signals (and possibly audio signals) to the notebook computer via wires.

However, the camera is fixed in the upper case in a manner so that an angle range which the camera sweeps is somewhat narrow. In order to get desired images, locations or angles of the whole portable device needs to be adjusted to point the camera in a desired direction. Great inconvenience is thus caused.

What is needed, therefore, is a portable device with a convenient integrated camera.

### SUMMARY OF THE INVENTION

A portable device with a detachable camera includes a case, a camera detachably received in the case, a wire electronically interconnecting the camera and the portable device, and a self-winding reel assembly. The reel assembly includes a reel, a scroll spring, a resilient lock, and a reel button. The reel is pivotably received in the case of the electronic device, and has a first end, an opposite second end for winding the wire therebetween and a first blocking portion attached to the second end. The scroll spring is attached to the first end for providing a rebounding force to the reel. The resilient lock detachably engages with the first blocking portion. The reel button engages with the resilient lock. When the reel button is pressed, the resilient lock moves out of the way of the first blocking portion, and the scroll spring urges the reel to rewind the wire.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a portable device in accordance with a preferred embodiment, with an integrated camera being accommodated therein;

FIG. 2 is an isometric view of the portable device of FIG. 1, with a second case removed;

FIG. 3 is an isometric view of the portable device of FIG. 2, with the camera separated from a first case;

FIG. 4 is an enlarged, isometric view of a circle IV of FIG. 3, with a first blocking sheet contacting a second blocking sheet;

FIG. 5 is an enlarged, isometric view of the circle IV of FIG. 3, with the first blocking sheet separated from the second blocking sheet; and

FIG. 6 is an enlarged, isometric view of the circle IV of FIG. 3, with the second blocking sheet having been urged away from the first blocking sheet by a pressure applied on a reel button.

### DETAILED DESCRIPTION OF THE INVENTION

In the following embodiment, a portable device such as a portable computer, with an integrated camera is used as an example for illustration.

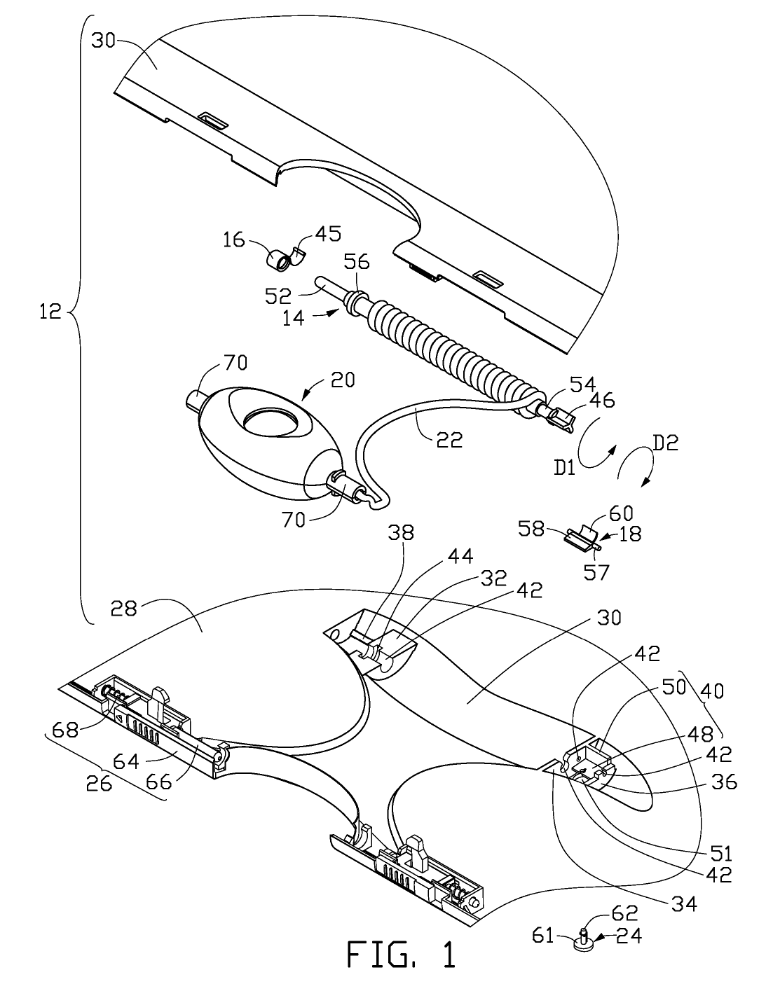

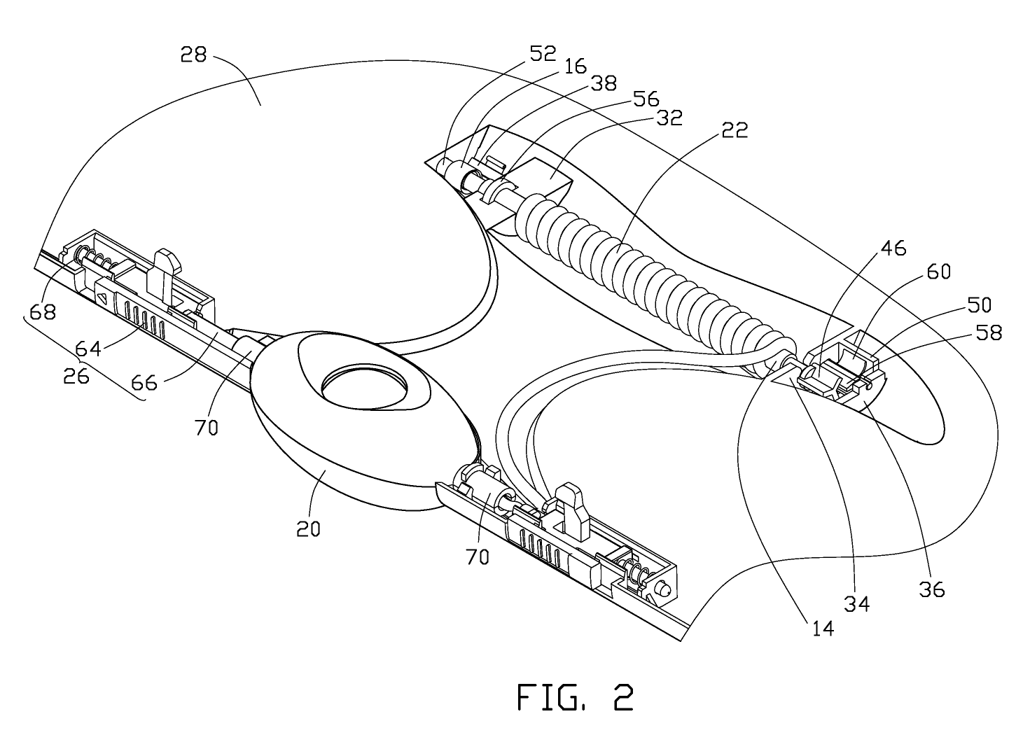

Referring to FIGS. 1 and 2, a portable device in accordance with a preferred embodiment includes a housing 12, a reel 14, a scroll spring 16 connected to the reel 14 for winding the reel 14, a resilient lock 18 for detachably engaging with the reel 14, a camera 20, a retractable wire 22 electronically connecting the camera 20 to the portable device, a reel button 24 for causing the wire 22 to be wound on the reel 14, and a positioning button 26 for securing the camera 20 in the housing 12. The housing 12 includes a first case 28, a second case 30 coupled to the first case 28, and a circuit board (not shown). The reel 14, the scroll spring 16, the resilient lock 18, the reel button 24, and the positioning button 26, are accommodated in the housing 12. The wire 22 electronically interconnects the camera 20 and the circuit board for transmitting signals.

The first case 28, which defines an elongated recess portion 30 therein, includes a first bearing portion 32, a second bearing portion 34, a third bearing portion 36, a fixing sheet 38, and an L-shaped sheet 40. The first bearing portion 32, the second bearing portion 34, and the third bearing portion 36 are spaced from and substantially parallel to each other, and arranged in series in the recess portion 30 along its longitudinal direction. A plurality of bearing holes 42 are respectively defined in the first bearing portion 32, the second bearing portion 34, and the third bearing portion 36 for receiving the reel 14, and the resilient lock 18. The first bearing portion 32 defines a groove portion 44 substantially perpendicular to an axis of the reel 14. At least one end of the fixing sheet 38 is secured to the recess portion 30. A first interspace (not labeled) is defined under the fixing sheet 38 and between the fixing sheet 38 and the recess portion 30 for allowing a free end 45 of the scroll spring 16 to be inserted therethrough. The L-shaped sheet 40 interconnects the second bearing portion 34 and the third bearing portion 36 and includes a first stopping sheet 48 and a second stopping sheet 50 perpendicularly extending from the first stopping sheet 48. A mounting hole 51 is defined through the first case 28 and the first stopping sheet 48.

The reel 14 includes a first end portion 52 supported by the first bearing portion 32 and an opposite end portion 54 supported by the second bearing portion 34. A flange portion 56 extends from a circumference of the reel 14 and is adjacent to the first end portion 52. The flange portion 56 is rotatably engaged in the groove portion 44 for preventing the reel 14 from moving along its axis. Three first blocking sheets 46 extend radially from the axis of the reel 14 in equal radians and are attached to the second end portion 54.

The resilient lock 18 includes a shaft 57, a second blocking sheet 58, and a resilient sheet 60. The second blocking sheet 58 and the resilient sheet 60 substantially oppositely extend radially from a circumference of the shaft 57. Two ends of the shaft 57 are inserted into the corresponding bearing holes 42. The second blocking sheet 58 is hindered by the first stopping sheet 48 whilst the resilient sheet 60 resiliently resists the second stopping sheet 50 so that the second blocking sheet 58 can be rotated about the shaft 58 between the first stopping sheet 48 and the second stopping sheet 50. A width of the second blocking sheet 58 in a direction perpendicular to the shaft 57 is greater than that of the first stopping sheet 48 so that a distal edge of the second blocking sheet 58 extends beyond an edge of the first stopping sheet 48.

Most of the scroll spring 16 is wound around the first end portion 52 of the reel 14 beside the free end 45 that is inserted through the first interspace under the fixing sheet 38. The scroll spring 16 can thus interconnect the reel 14 and the first case 28.

The reel button 24 includes a pressing portion 61 for being pressed and a pressing post 62 extending from the pressing portion 61. The pressing post 62 is inserted into the mounting hole 51 for contacting and applying a pressure onto the second blocking sheet 58. The positioning button 26 is mounted into the first case 28 and includes a sliding portion 64, a positioning pin 66 attached to the sliding portion 64, and a spring 68 for resiliently urging the positioning pin 66.

The camera 20 is partially and detachably accommodated in the first case 28 and includes opposite positioning tubes 70. One positioning tube 70 is connected to the wire 22, and the other positioning tube 70 is detachably engaged around the positioning pin 66.

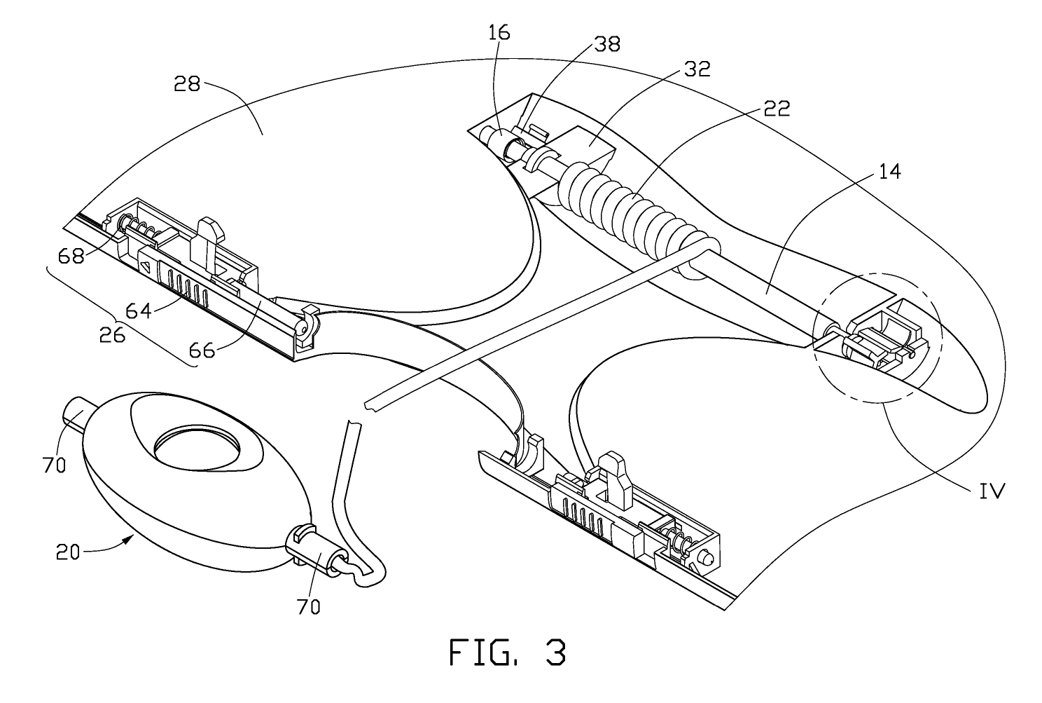

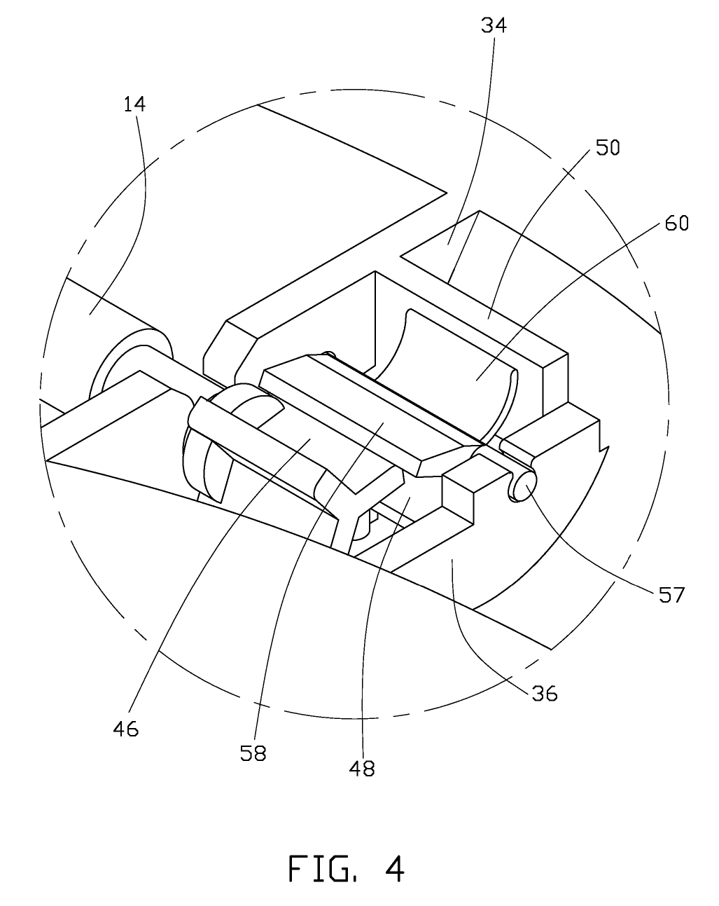

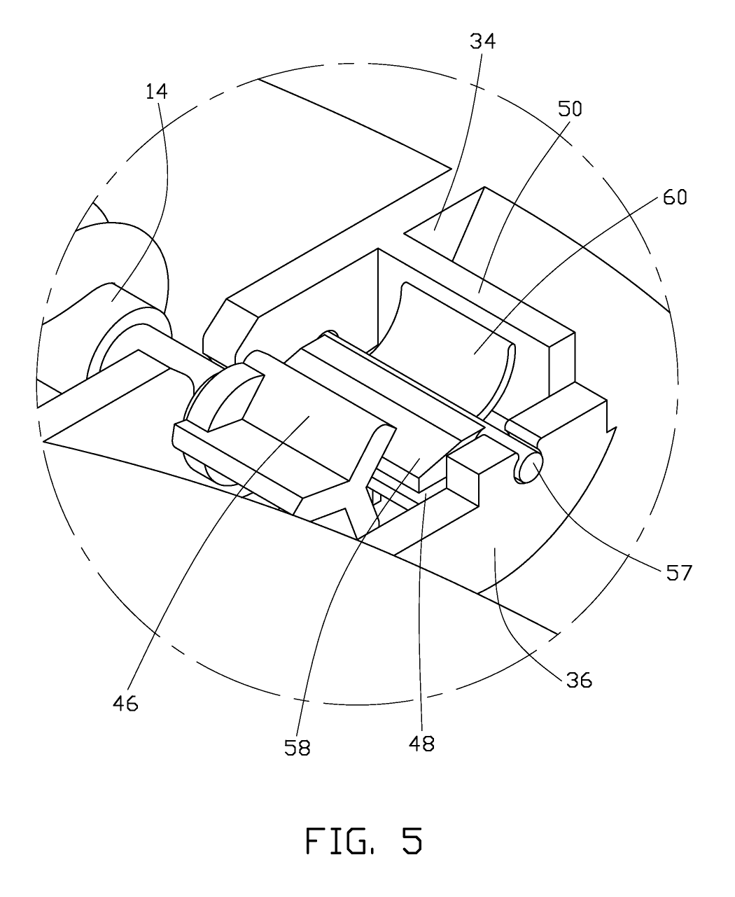

Referring also to FIGS. 3 to 5, in use, the wire 22 is received in the first case 28, and most of the wire 22 is wound about the reel 14. The scroll spring 16 is in a relaxed state. When the camera 20 is drawn out from the first case 28, the wire 22 is pulled outwards, rotating the reel 14 in an anti-clockwise direction D2 when viewed from the second end portion thereof, the scroll spring 16 is tightened, thereby storing energy. The first blocking sheets 46 rotate in the anti-clockwise direction D2, individually lifting up the distal end of the second blocking sheet 58 (see FIG. 4) and overcoming a resilient force produced by the resilient sheet 60 to pass over the distal edge of the second blocking sheet 58. This causes the second blocking sheet 58 to rotate out of the way of the first blocking sheets 46. The wire 22 is thus continuously pulled until the desired length is exposed. If a desired length is wanted, a user stops pulling the wire 22 out, the scroll spring 16 rebounds partly to cause the reel 14 and the first blocking sheets 46 to rotate in a clockwise direction D1 until one of the first blocking sheets 46 is stopped by the second blocking sheet 58, thus the wire 22 is prevented from further retracting. Locations or angles of the camera 20 can be freely changed to aim at specific objects without moving the portable device.

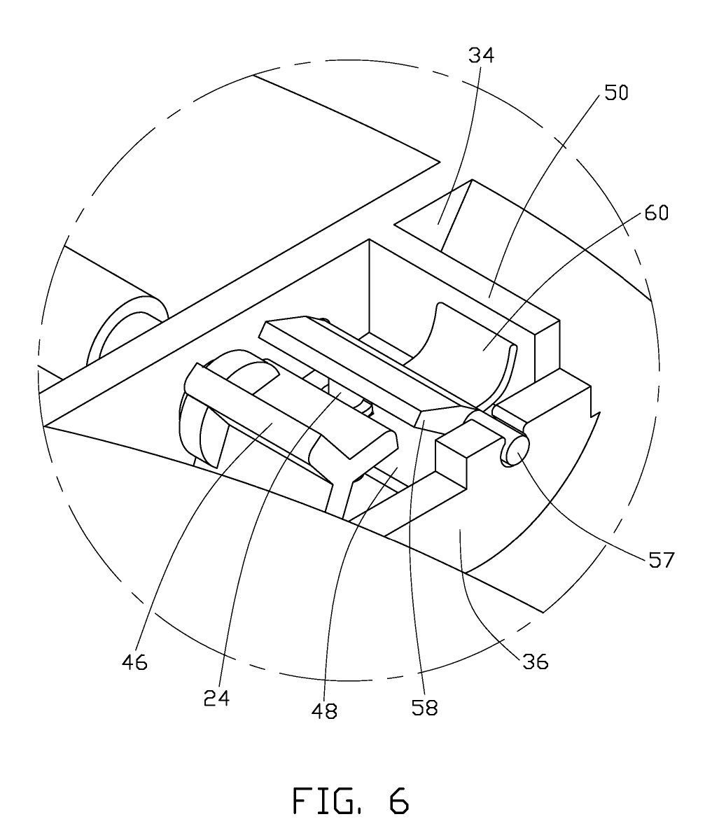

Referring also to FIG. 6, when it is desired that the wire 22 be retracted, the user needs only press the reel button 24. The pressing post 62 applies a pressure onto the second blocking sheet 58 to move the second blocking sheet 58 out of the way of the first blocking sheets 46. The scroll spring 16 rebounds to cause the reel 14 to rotate in the clockwise direction D1 that retracts the wire 22 until the wire 22 is entirely rewound.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable device with a detachable camera comprising:
a case;
a camera detachably received in the case;
a wire electronically interconnecting the camera and the portable device;
a self-winding reel assembly comprising:
a reel pivotably received in the case and comprising a first end, an opposite second end configured for winding the wire therebetween and a first blocking portion attached to the second end;
a scroll spring attached to the first end and configured for providing a rebounding force to urge the reel to rotate in a direction that winds the wire;
a resilient lock movably mounted to the case configured for detachably engaging with the first blocking portion to stop the reel from rotating in the direction that winds the wire after the camera is pulled out of the case; and
a reel button configured for driving the resilient lock to disengage from the resilient lock; wherein
when the reel button is pressed, the resilient lock is driven by the reel button to move out of the way of the first blocking portion, and the scroll spring urges the reel to rewind the wire.

2. The portable device as claimed in claim 1, wherein the case comprises a first bearing portion for supporting the first end, an opposite second bearing portion for supporting the second end, the first bearing portion and the second bearing portion are spaced from and substantially parallel to each other, the first bearing portion defines a groove portion substantially perpendicular to an axis of the reel, the reel comprises a flange portion formed on a circumference of the reel and substantially perpendicular to the axis, the flange portion is rotatably received in the groove portion for preventing the reel from being movable along the axis.

3. The portable device as claimed in claim 2, wherein the first blocking portion comprises a plurality of first blocking sheets radially extending from the axis and configured for selectively engaging with the resilient lock when the reel button is released.

4. The portable device as claimed in claim 3, wherein the resilient lock comprises a shaft pivotably mounted with respect to the case, a second blocking portion radially extending from a circumference of the shaft for selectively and detachably engaging with one of the first blocking sheets, and a resilient portion attached to the circumference of the shaft and opposite to the second blocking portion for resiliently restricting a rotation of the second blocking portion.

5. The portable device as claimed in claim 4, wherein the case further comprises a third bearing portion spaced from and substantially parallel to the second bearing portion, the third bearing portion and the first bearing portion are arranged at opposite sides of the second bearing portion and configured for supporting the resilient lock thereon.

6. The portable device as claimed in claim 5, wherein an L-shaped stopping member interconnects the second bearing portion and the third bearing portion, and comprises a first stopping sheet for detachably hindering the second blocking portion and a second stopping sheet perpendicularly extending from the first stopping sheet for supporting and resisting the resilient portion.

7. The portable device as claimed in claim 6, wherein the second blocking portion has one portion extends beyond an edge of the first stopping sheet so that said portion of the second blocking portion is capable of detachably hindering the first blocking sheets and the reel button is capable of driving the second blocking portion to disengage from the first blocking sheet via pushing said one portion of the second blocking portion.

8. The portable device as claimed in claim 4, wherein the reel button comprises a pressing portion configured for being pressed and a contacting post configured for inserting into an insertion hole defined in the case to contact and apply pressure to the second blocking portion.

9. The portable device as claimed in claim 4, wherein the case further comprises a positioning button configured for holding the camera in the case.

10. The portable device as claimed in claim 9, wherein the camera comprises a positioning tube, the positioning button comprises a sliding portion, a positioning pin attached to the sliding portion for detachably engaging in the positioning tube, and a spring configured for resiliently urging the positioning pin.

11. A self-winding reel assembly comprising:
a case comprising a first bearing portion and a second bearing portion, the first bearing portion and the second bearing portion being arranged in the case and spaced from each other;
a resilient lock pivotally attached to the second bearing portion, the resilient lock is configured for detachably engaging with the first blocking portion;
a reel pivotably received in the case and pivotably attached between the first and second bearing portions for winding a wire thereon, the reel comprising a first end, an opposite second end configured for winding the wire therebetween, and a first blocking portion extending from an axis of the reel attached to the second end;
a scroll spring interconnecting the case and the first end for rewinding the wire; and
a reel button is movably mounted to the case and configured for driving the resilient lock; wherein
when the reel button is pressed, the resilient lock is driven by the reel button to disengage from the first blocking portion, and the scroll spring reverses the reel to rewind the wire.

12. The self-winding reel assembly as claimed in claim 1, wherein the first bearing portion defines a groove portion substantially perpendicular to an axis of the reel, the reel comprises a flange portion formed on a circumference of the reel and substantially perpendicular to the axis, the flange portion is rotatably received in the groove portion for preventing the reel from being movable along the axis.

13. The self-winding reel assembly as claimed in claim 12, wherein the first blocking portion comprises a plurality of first blocking sheets radially extending from the axis and configured for selectively engaging with the resilient lock when the reel button is released.

14. The self-winding reel assembly as claimed in claim 13, wherein the resilient lock comprises a shaft, a second blocking portion radially extending from a circumference of the shaft for selectively and detachably engaging with one of the first blocking sheets, and a resilient portion attached to the circumference of the shaft and opposite to the second blocking portion for resiliently restricting a rotation of the second blocking portion.

15. The self-winding reel assembly as claimed in claim 14, wherein the case further comprises a third bearing portion, the third bearing portion and the first bearing portion are arranged at opposite sides of the second bearing portion and configured for supporting the resilient lock thereon.

16. The self-winding reel assembly as claimed in claim 15, wherein an L-shaped stopping member interconnects the second bearing portion and the third bearing portion, and comprises a first stopping sheet for detachably hindering the second blocking portion and a second stopping sheet perpendicularly extending from the first stopping sheet for supporting and resisting the resilient portion.

17. The self-winding reel assembly as claimed in claim 16, wherein the second blocking portion overlaps an edge of the first stopping sheet so that the second blocking portion is capable of detachably hindering one of the first blocking sheets.

18. The self-winding reel assembly as claimed in claim 14, wherein the reel button comprises a contacting post configured for inserting into an insertion hole defined in the case for contacting the second blocking portion.

19. An electronic device with a self-winding reel assembly comprising:
a case comprising a first bearing portion and a second bearing portion spaced from each other;
a camera detachably received in the case;
a wire electronically connecting the camera with the electronic device;
a self-winding reel assembly comprising:
a reel configured for winding the wire thereon, the reel comprising a first end and an opposite second end pivotably mounted to the first and second bearing portions, the reel being pivotable about the bearing portions in two opposite directions to unwind or wind the wire;
a blocking portion secured to the second end of the reel and being rotatable with the reel;
a scroll spring attached to the first end of the reel configured for providing a rebounding force to urge the reel to rotate in a direction that winds the wire;
a resilient lock mounted to the case configured to detachably engage with the blocking portion for preventing the reel rotating in the direction that winds the wire after the camera is pulled out of the case; and
a reel button movably attached to the case and exposed to outside of the case, the reel button being capable of driving the resilient lock to disengage from the first blocking portion thereby allowing the reel to rewind the wire under the rebounding force of the scroll spring.

20. The electronic device as claimed in claim 19, wherein the blocking portion comprises at least one first blocking structure, and the resilient lock comprises a second blocking structure, the at least one first blocking structure being capable of overcoming a resilient force produced by the resilient lock and passing over the second blocking structure when the reel rotates in the direction that unwind the wire and being blocked by the second blocking structure when the reel rotates in an opposite direction that wind the wire.

21. The electronic device as claimed in claim 20, wherein the resilient lock further comprises a resilient sheet abutting against the case configured for urging the resilient lock back to a position where the second blocking structure is capable of blocking the first blocking portion to prevent the reel rotating in an another direction that wind the wire.
